(19) United States
(12) Patent Application Publication
(10) Pub. No.: US 2025/0227305 A1
(43) Pub. Date: Jul. 10, 2025

(54) DESCRIPTORS FOR FILM GRAIN SYNTHESIS

(71) Applicant: Tencent America LLC, Palo Alto, CA (US)

(72) Inventors: Arianne HINDS, Palo Alto, CA (US); Stephan WENGER, Hillsborough, CA (US)

(73) Assignee: Tencent America LLC, Palo Alto, CA (US)

(21) Appl. No.: 19/014,008

(22) Filed: Jan. 8, 2025

Related U.S. Application Data
(60) Provisional application No. 63/619,306, filed on Jan. 9, 2024.

(51) Int. Cl. H04N 19/70; G06T 9/00; H04N 19/132; H04N 19/167; H04N 19/172

(52) U.S. Cl. CPC H04N 19/70; G06T 9/00; H04N 19/132; H04N 19/167; H04N 19/172

(57) ABSTRACT

A method of video decoding includes receiving a coded video bitstream comprising coded information of a coded picture and receiving a supplemental enhancement information (SEI) message associated with the coded picture. The SEI message indicates one or more of (i) a type of film grain, (ii) a purpose of the film grain, and (iii) essentiality of the film grain that is applied to a first region including one or more first samples in the coded picture. The method of video decoding includes reconstructing the coded picture that is associated with the SEI message.

### RELATED APPLICATION

The present application claims the benefit of priority to U.S. Provisional Application No. 63/619,306, “DESCRIPTORS FOR FILM GRAIN SYNTHESIS” filed on Jan. 9, 2024, which is incorporated by reference herein in its entirety.

### TECHNICAL FIELD

The present disclosure describes aspects generally related to video coding, including film grain synthesis.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include methods and apparatuses for video encoding/decoding. In some examples, an apparatus for video decoding/encoding includes processing circuitry.

A method of video decoding includes receiving a coded video bitstream comprising coded information of a coded picture and receiving a supplemental enhancement information (SEI) message associated with the coded picture, and reconstructing the coded picture that is associated with the SEI message. The SEI message indicates one or more of (i) a type of film grain, (ii) a purpose of the film grain, and (iii) essentiality of the film grain that is applied to a first region including one or more first samples in the coded picture.

A method of video encoding includes encoding a picture in a video bitstream; and encoding a supplemental enhancement information (SEI) message associated with the picture. The SEI message indicates one or more of (i) a type of film grain, (ii) a purpose of the film grain, and (iii) essentiality of the film grain that is applied to a first region including one or more first samples in the picture.

Some aspects of the disclosure provide a method of processing visual media data. The method includes processing a bitstream of visual media data according to a format rule. The bitstream includes coded information of a coded picture and a supplemental enhancement information (SEI) message being associated with the coded picture. The SEI message indicates one or more of (i) a type of film grain, (ii) a purpose of the film grain, and (iii) essentiality of the film grain that is applied to a first region including one or more first samples in the coded picture. The format rule specifies that the coded picture that is associated with the SEI message is reconstructed.

According to another aspect of the disclosure, an apparatus is provided. The apparatus includes processing circuitry. The processing circuitry can be configured to perform any of the described methods for video decoding/encoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 shows a block diagram of a communication system in some examples.

FIG. 2 shows a block diagram of a video processing system in some examples.

FIG. 3 shows a block diagram of a video decoder in some examples.

FIG. 4 shows a block diagram of a video encoder in some examples.

FIG. 5 shows a layout of a coded video sequence (CVS) in some examples.

FIG. 6 shows an example of a SEI message that includes information indicating a type of film grain, essentiality of the film grain, and/or a purpose of the film grain according to an aspect of the disclosure.

FIG. 7 shows an example of a syntax for the SEI message according to an aspect of the disclosure.

FIG. 8A shows an example of values that a syntax element (e.g., fge_film_grain_type) may have according to an aspect of the disclosure.

FIG. 8B shows an example of values that a syntax element (e.g., fge_film_grain_purpose) may have according to an aspect of the disclosure.

FIG. 8C shows an example of values that a syntax element (e.g., fge_film_grain_essentiality may have according to an aspect of the disclosure.

FIG. 9 shows a flow chart outlining a process (900) according to an aspect of the disclosure.

FIG. 10 shows a flow chart outlining a process (1000) according to an aspect of the disclosure.

FIG. 11 is a schematic illustration of a computer system in accordance with an aspect.

### DETAILED DESCRIPTION OF EMBODIMENTS

Some aspects of the disclosure provide techniques of video coding (e.g., encoding and decoding). In some examples, the techniques are used in an SEI message indicating descriptors for film grain synthesis.

Video coding techniques can compress video data. Video coding and decoding using inter-picture prediction with motion compensation has been used in various examples. In some examples, uncompressed digital video can include a series of pictures, each picture having a spatial dimension of, for example, 1920×1080 luminance samples and associated chrominance samples. The series of pictures can have a fixed or variable picture rate (informally also known as frame rate), of, for example 60 pictures per second or 60 Hz. Uncompressed video has significant bitrate requirements. For example, 1080p60 4:2:0 video at 8 bit per sample (1920×1080 luminance sample resolution at 60 Hz frame rate) requires close to 1.5 Gbit/s bandwidth. An hour of such video requires more than 600 GByte of storage space.

Video coding techniques (e.g., encoding and decoding techniques) can reduce redundancy in the input video signal, through compression. Compression can help reducing aforementioned bandwidth or storage space requirements, in some cases by two orders of magnitude or more. Both lossless and lossy compression, as well as a combination thereof can be employed. Lossless compression refers to techniques where an exact copy of the original signal can be reconstructed from the compressed original signal. When using lossy compression, the reconstructed signal may not be identical to the original signal, but the distortion between original and reconstructed signal is small enough to make the reconstructed signal useful for the intended application. In the case of video, lossy compression is widely employed. The amount of distortion tolerated depends on the application; for example, users of certain consumer streaming applications may tolerate higher distortion than users of television contribution applications. The compression ratio achievable can reflect that: higher allowable/tolerable distortion can yield higher compression ratios.

Video encoders and decoders can utilize techniques from several broad categories, including, for example, motion compensation, transform, quantization, and entropy coding, some of which will be introduced below.

Disclosed herein are systems and methods for video coding in at least one processor. For example, a method of video decoding can include receiving at least one picture including an SEI message comprising at least one syntax element indicative of at least one of a forward truncation function or a reverse truncation function; and reconstructing the coded picture comprising samples, in which the numbering range of the samples is determined by the at least one of the forward truncation function or the reverse truncation function that is indicated by the SEI message.

In certain environments, such as in video coding for consumption by machines (in contrast to humans), the requirement for a bitstream to pass a quality threshold based on human perception may not be required. Instead, the quality can be sufficient for machine consumption even if not adequate for human consumption.

In some examples, a technique to reduce the sample value range is used, the technique can use a preprocessing performed before encoding, and a corresponding post-processing after decoding. According to an aspect of the disclosure, doing so for natural sequences can lead to artifacts such as banding which are not pleasing to a human recipient, but may be acceptable for machine consumption (such as, for example image analysis for high-contrast content such as bar codes). In some examples, the bit depth of an VVC picture could be reduced from 10 bits to 5 bits-corresponding to 32 grayscale and color component levels. For example, in an original picture, 10 bits are used to represent grayscale levels, and after the bit depth reduction, 5 bits (e.g., the most significant 5 bits in the 10 bits, and the like) are used to represent grayscale levels. In some examples, when such a pre-processing is conducted before encoding, the decoder and associated processor need to know how the pre-processing was performed. Some aspects of the disclosure provide techniques for providing such information for video coding.

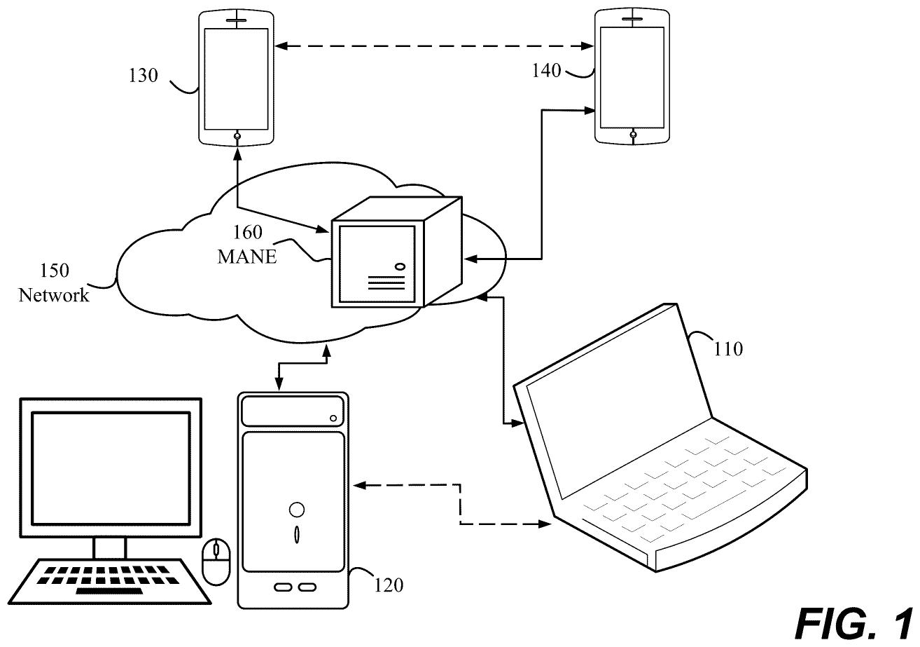

FIG. 1 shows a block diagram of a communication system (100) in some examples. The system (100) includes at least two terminals, such as a first terminal (110) and a second terminal (120) shown in FIG. 1, that are interconnected via a network (150). In some examples, unidirectional transmission of data is performed in the communication system (100). In an example, for the unidirectional transmission of data, the first terminal (110) can code video data at a local location for transmission to the second terminal (120) via the network (150). The second terminal (120) can receive the coded video data of the other terminal, such as the first terminal (110), from the network (150), decode the coded data and display the recovered video data. It is noted that unidirectional data transmission can be commonly used in media serving applications and the like.

FIG. 1 also shows a second pair of terminals, such as a third terminal (130) and a fourth terminal (140), that are configured to support bidirectional transmission of coded video that may occur, for example, during videoconferencing. For bidirectional transmission of data, each of the third terminal (130) and the fourth terminal (140) can code video data captured at a local location for transmission to the other terminal via the network (150). Each of the third terminal (130) and the fourth terminal (140) can also receive the coded video data transmitted by the other terminal, can decode the coded data and display the recovered video data at a local display device.

It is noted that while in FIG. 1, the terminals (110), (120), (130) and (140) are illustrated as servers, personal computers and smart phones, but the present disclosure is not limited to such terminal examples. Aspects of the present disclosure can include application with laptop computers, tablet computers, media players and/or dedicated video conferencing equipment. The network (150) represents any number of networks that convey coded video data among the terminals (110), (120), (130) and (140), including for example wireline and/or wireless communication networks. The network (150) can exchange data in circuit-switched and/or packet-switched channels. Representative networks include telecommunications networks, local area networks, wide area networks and/or the Internet. For the purposes of the present discussion, the architecture and topology of the network (150) can be immaterial to the operation of the present disclosure unless explained herein below. In some examples, the network (150) includes Media Aware Network Elements (MANEs, 160) that may be included in the transmission path between, for example, the third terminal (130) and fourth terminal (140). In some examples, a MANE (160) can selective forward of parts of the media data to react to network congestions, media switching, media mixing, archival, and similar tasks commonly performed by a service provider rather than an end user. Such MANEs may be able to parse and react on a limited part of the media conveyed over the network, for example syntax elements related to the network abstraction layer of video coding technologies or standards.

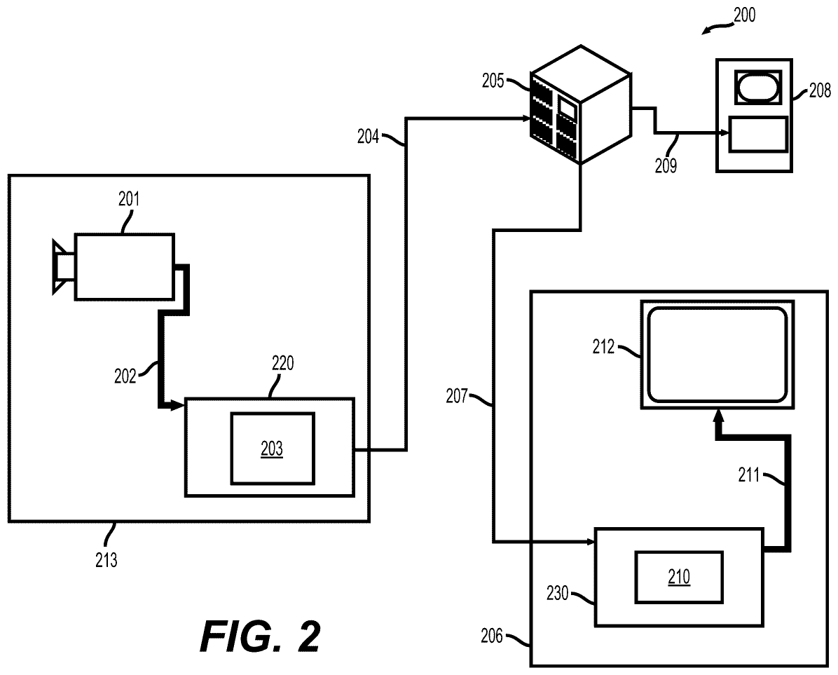

FIG. 2 shows a block diagram of a video processing system (200) in some examples. The video processing system (200) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (200) includes a capture subsystem (213), that can include a video source (201), for example a digital camera, creating for example a stream of video pictures (202) that are uncompressed. In an example, the stream of video pictures (202) includes samples that are taken by the digital camera. The stream of video pictures (202), depicted as a bold line to emphasize a high data volume when compared to encoded video data (204) (or coded video bitstreams), can be processed by an electronic device (220) that includes a video encoder (203) coupled to the video source (201). The video encoder (203) can include hardware, software, or a combination thereof to enable or implement aspects of the disclosed subject matter as described in more detail below. The encoded video data (204) (or encoded video bitstream), depicted as a thin line to emphasize the lower data volume when compared to the stream of video pictures (202), can be stored on a streaming server (205) for future use. One or more streaming client subsystems, such as client subsystems (206) and (208) in FIG. 2 can access the streaming server (205) to retrieve copies (207) and (209) of the encoded video data (204). A client subsystem (206) can include a video decoder (210), for example, in an electronic device (230). The video decoder (210) decodes the incoming copy (207) of the encoded video data and creates an outgoing stream of video pictures (211) that can be rendered on a display (212) (e.g., display screen) or other rendering device (not depicted). In some streaming systems, the encoded video data (204), (207), and (209) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (220) and (230) can include other components (not shown). For example, the electronic device (220) can include a video decoder (not shown) and the electronic device (230) can include a video encoder (not shown) as well.

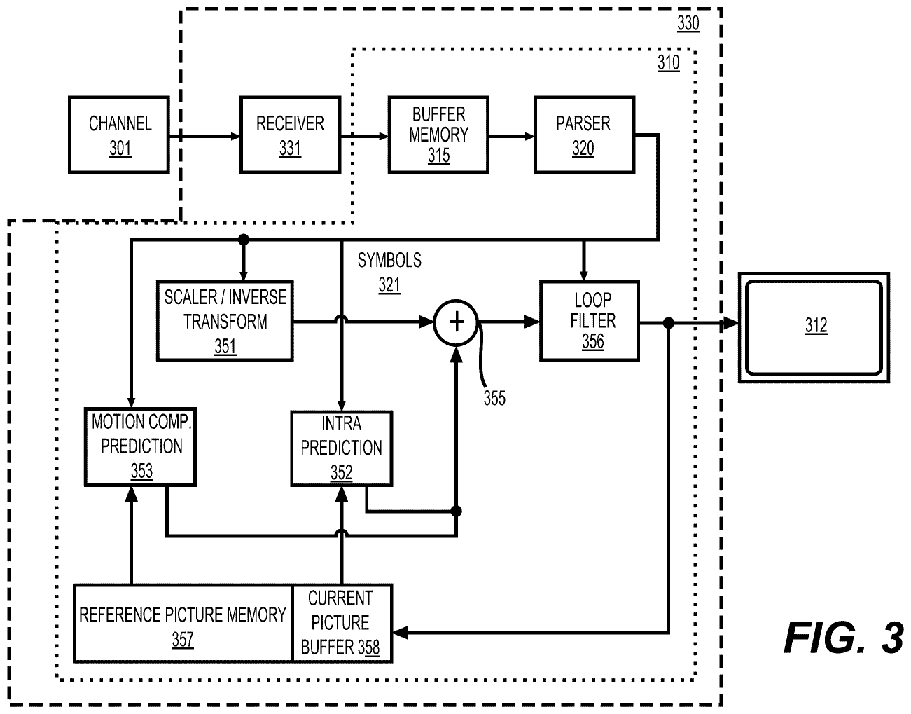

FIG. 3 shows an exemplary block diagram of a video decoder (310). The video decoder (310) can be included in an electronic device (330). The electronic device (330) can include a receiver (331) (e.g., receiving circuitry). The video decoder (310) can be used in the place of the video decoder (210) in the FIG. 2 example.

The receiver (331) can receive one or more coded video sequences, included in a bitstream for example, to be decoded by the video decoder (310). In an aspect, one coded video sequence is received at a time, where the decoding of each coded video sequence is independent from the decoding of other coded video sequences. The coded video sequence may be received from a channel (301), which may be a hardware/software link to a storage device which stores the encoded video data. The receiver (331) may receive the encoded video data with other data, for example, coded audio data and/or ancillary data streams, that may be forwarded to their respective using entities (not depicted). The receiver (331) may separate the coded video sequence from the other data. To combat network jitter, a buffer memory (315) may be coupled in between the receiver (331) and an entropy decoder/parser (320) (“parser (320)” henceforth). In certain applications, the buffer memory (315) is part of the video decoder (310). In others, it can be outside of the video decoder (310) (not depicted). In still others, there can be a buffer memory (not depicted) outside of the video decoder (310), for example to combat network jitter, and in addition another buffer memory (315) inside the video decoder (310), for example to handle playout timing. When the receiver (331) is receiving data from a store/forward device of sufficient bandwidth and controllability, or from an isosynchronous network, the buffer memory (315) may not be needed, or can be small. For use on best effort packet networks such as the Internet, the buffer memory (315) may be required, can be comparatively large and can be advantageously of adaptive size, and may at least partially be implemented in an operating system or similar elements (not depicted) outside of the video decoder (310).

The video decoder (310) may include the parser (320) to reconstruct symbols (321) from the coded video sequence. Categories of those symbols include information used to manage operation of the video decoder (310), and potentially information to control a rendering device such as a render device (312) (e.g., a display screen) that is not an integral part of the electronic device (330) but can be coupled to the electronic device (330), as shown in FIG. 3. The control information for the rendering device(s) may be in the form of Supplemental Enhancement Information (SEI) messages or Video Usability Information (VUI) parameter set fragments (not depicted). The parser (320) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (320) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (320) may also extract from the coded video sequence information such as transform coefficients, quantizer parameter values, motion vectors, and so forth.

The parser (320) may perform an entropy decoding/parsing operation on the video sequence received from the buffer memory (315), so as to create symbols (321).

Reconstruction of the symbols (321) can involve multiple different units depending on the type of the coded video picture or parts thereof (such as: inter and intra picture, inter and intra block), and other factors. Which units are involved, and how, can be controlled by subgroup control information parsed from the coded video sequence by the parser (320). The flow of such subgroup control information between the parser (320) and the multiple units below is not depicted for clarity.

Beyond the functional blocks already mentioned, the video decoder (310) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (351). The scaler/inverse transform unit (351) receives a quantized transform coefficient as well as control information, including which transform to use, block size, quantization factor, quantization scaling matrices, etc. as symbol(s) (321) from the parser (320). The scaler/inverse transform unit (351) can output blocks comprising sample values, that can be input into aggregator (355).

In some cases, the output samples of the scaler/inverse transform unit (351) can pertain to an intra coded block. The intra coded block is a block that is not using predictive information from previously reconstructed pictures, but can use predictive information from previously reconstructed parts of the current picture. Such predictive information can be provided by an intra picture prediction unit (352). In some cases, the intra picture prediction unit (352) generates a block of the same size and shape of the block under reconstruction, using surrounding already reconstructed information fetched from the current picture buffer (358). The current picture buffer (358) buffers, for example, partly reconstructed current picture and/or fully reconstructed current picture. The aggregator (355), in some cases, adds, on a per sample basis, the prediction information the intra prediction unit (352) has generated to the output sample information as provided by the scaler/inverse transform unit (351).

In other cases, the output samples of the scaler/inverse transform unit (351) can pertain to an inter coded, and potentially motion compensated, block. In such a case, a motion compensation prediction unit (353) can access reference picture memory (357) to fetch samples used for prediction. After motion compensating the fetched samples in accordance with the symbols (321) pertaining to the block, these samples can be added by the aggregator (355) to the output of the scaler/inverse transform unit (351) (in this case called the residual samples or residual signal) so as to generate output sample information. The addresses within the reference picture memory (357) from where the motion compensation prediction unit (353) fetches prediction samples can be controlled by motion vectors, available to the motion compensation prediction unit (353) in the form of symbols (321) that can have, for example X, Y, and reference picture components. Motion compensation also can include interpolation of sample values as fetched from the reference picture memory (357) when sub-sample exact motion vectors are in use, motion vector prediction mechanisms, and so forth.

The output samples of the aggregator (355) can be subject to various loop filtering techniques in the loop filter unit (356). Video compression technologies can include in-loop filter technologies that are controlled by parameters included in the coded video sequence (also referred to as coded video bitstream) and made available to the loop filter unit (356) as symbols (321) from the parser (320). Video compression can also be responsive to meta-information obtained during the decoding of previous (in decoding order) parts of the coded picture or coded video sequence, as well as responsive to previously reconstructed and loop-filtered sample values.

The output of the loop filter unit (356) can be a sample stream that can be output to the render device (312) as well as stored in the reference picture memory (357) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (320)), the current picture buffer (358) can become a part of the reference picture memory (357), and a fresh current picture buffer can be reallocated before commencing the reconstruction of the following coded picture.

The video decoder (310) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (331) may receive additional (redundant) data with the encoded video. The additional data may be included as part of the coded video sequence(s). The additional data may be used by the video decoder (310) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

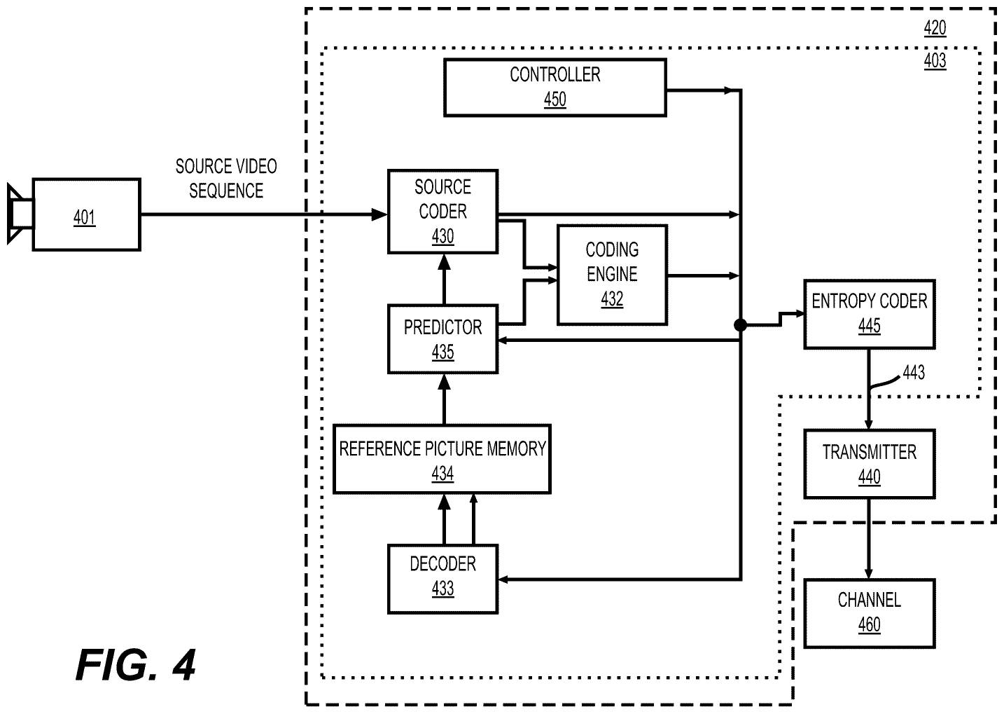

FIG. 4 shows an exemplary block diagram of a video encoder (403). The video encoder (403) is included in an electronic device (420). The electronic device (420) includes a transmitter (440) (e.g., transmitting circuitry). The video encoder (403) can be used in the place of the video encoder (203) in the FIG. 2 example.

The video encoder (403) may receive video samples from a video source (401) (that is not part of the electronic device (420) in the FIG. 4 example) that may capture video image(s) to be coded by the video encoder (403). In another example, the video source (401) is a part of the electronic device (420).

The video source (401) may provide the source video sequence to be coded by the video encoder (403) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (401) may be a storage device storing previously prepared video. In a videoconferencing system, the video source (401) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (403) may code and compress the pictures of the source video sequence into a coded video sequence (443) in real time or under any other time constraints as required. Enforcing appropriate coding speed is one function of a controller (450). In some aspects, the controller (450) controls other functional units as described below and is functionally coupled to the other functional units. The coupling is not depicted for clarity. Parameters set by the controller (450) can include rate control related parameters (picture skip, quantizer, lambda value of rate-distortion optimization techniques, . . . ), picture size, group of pictures (GOP) layout, maximum motion vector search range, and so forth. The controller (450) can be configured to have other suitable functions that pertain to the video encoder (403) optimized for a certain system design.

In some aspects, the video encoder (403) is configured to operate in a coding loop. As an oversimplified description, in an example, the coding loop can include a source coder (430) (e.g., responsible for creating symbols, such as a symbol stream, based on an input picture to be coded, and a reference picture(s)), and a (local) decoder (433) embedded in the video encoder (403). The decoder (433) reconstructs the symbols to create the sample data in a similar manner as a (remote) decoder also would create. The reconstructed sample stream (sample data) is input to the reference picture memory (434). As the decoding of a symbol stream leads to bit-exact results independent of decoder location (local or remote), the content in the reference picture memory (434) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (433) can be the same as a “remote” decoder, such as the video decoder (310), which has already been described in detail above in conjunction with FIG. 3. Briefly referring also to FIG. 3, however, as symbols are available and encoding/decoding of symbols to a coded video sequence by an entropy coder (445) and the parser (320) can be lossless, the entropy decoding parts of the video decoder (310), including the buffer memory (315), and parser (320) may not be fully implemented in the local decoder (433).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (430) may perform motion compensated predictive coding, which codes an input picture predictively with reference to one or more previously coded picture from the video sequence that were designated as “reference pictures.” In this manner, the coding engine (432) codes differences between pixel blocks of an input picture and pixel blocks of reference picture(s) that may be selected as prediction reference(s) to the input picture.

The local video decoder (433) may decode coded video data of pictures that may be designated as reference pictures, based on symbols created by the source coder (430). Operations of the coding engine (432) may advantageously be lossy processes. When the coded video data may be decoded at a video decoder (not shown in FIG. 4), the reconstructed video sequence typically may be a replica of the source video sequence with some errors. The local video decoder (433) replicates decoding processes that may be performed by the video decoder on reference pictures and may cause reconstructed reference pictures to be stored in the reference picture memory (434). In this manner, the video encoder (403) may store copies of reconstructed reference pictures locally that have common content as the reconstructed reference pictures that will be obtained by a far-end video decoder (absent transmission errors).

The predictor (435) may perform prediction searches for the coding engine (432). That is, for a new picture to be coded, the predictor (435) may search the reference picture memory (434) for sample data (as candidate reference pixel blocks) or certain metadata such as reference picture motion vectors, block shapes, and so on, that may serve as an appropriate prediction reference for the new pictures. The predictor (435) may operate on a sample block-by-pixel block basis to find appropriate prediction references. In some cases, as determined by search results obtained by the predictor (435), an input picture may have prediction references drawn from multiple reference pictures stored in the reference picture memory (434).

The controller (450) may manage coding operations of the source coder (430), including, for example, setting of parameters and subgroup parameters used for encoding the video data.

Output of all aforementioned functional units may be subjected to entropy coding in the entropy coder (445). The entropy coder (445) translates the symbols as generated by the various functional units into a coded video sequence, by applying lossless compression to the symbols according to technologies such as Huffman coding, variable length coding, arithmetic coding, and so forth.

The transmitter (440) may buffer the coded video sequence(s) as created by the entropy coder (445) to prepare for transmission via a communication channel (460), which may be a hardware/software link to a storage device which would store the encoded video data. The transmitter (440) may merge coded video data from the video encoder (403) with other data to be transmitted, for example, coded audio data and/or ancillary data streams (sources not shown).

The controller (450) may manage operation of the video encoder (403). During coding, the controller (450) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (403) may perform coding operations according to a predetermined video coding technology or standard, such as ITU-T Rec. H.266. In its operation, the video encoder (403) may perform various compression operations, including predictive coding operations that exploit temporal and spatial redundancies in the input video sequence. The coded video data, therefore, may conform to a syntax specified by the video coding technology or standard being used.

In an aspect, the transmitter (440) may transmit additional data with the encoded video. The source coder (430) may include such data as part of the coded video sequence. Additional data may comprise temporal/spatial/SNR enhancement layers, other forms of redundant data such as redundant pictures and slices, supplementary enhancement information (SEI) messages, Visual Usability Information (VUI) parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (203) and (403), and the video decoders (210) and (310) can be implemented using any suitable technique. In an aspect, the video encoders (203) and (403) and the video decoders (210) and (310) can be implemented using one or more integrated circuits. In another aspect, the video encoders (203) and (403), and the video decoders (210) and (310) can be implemented using one or more processors that execute software instructions.

A video encoder and a video decoder may utilize techniques from multiple broad categories, including, for example, motion compensation, transform, quantization, entropy coding, carriage of supplemental information (e.g., metadata that may describe the imagery in a coded bitstream), and the like.

In an aspect, a compressed video and/or a picture may be augmented, in the video bitstream, by supplementary enhancement information, for example in the form of Supplementary Enhancement Information (SEI) Messages or VUI. In some examples, video coding standards can include specifications for SEI and VUI. In some examples, SEI and VUI information may also be specified in stand-alone specifications that may be referenced by the video coding specifications.

Techniques used in video coding standards may include one or more SEI messages which may enable the carriage of information, for example, within the coded bitstream, that is supplemental to the coded video. Such SEI information may or may not be directly related to the video coding process, e.g., as specified by a video standard, e.g., H.264|AVC, H.265|HEVC, H.266|VVC, and/or the like. In many cases, the information in SEI message(s) may be relevant to application processes that are executed in tandem with, or closely following, a video decoding process. For example, such applications may include a rendering process that uses certain SEI messages to adjust brightness or a color space of decoded video frames (also referred to as pictures) prior to presentation by a display device.

In an aspect, within the current standards that utilize SEI messages, e.g., H.264|AVC, H.265|HEVC, and H.266|VVC, SEI messages may be separated into two classes: a first class that may impact a video decoding process, and a second class that does not impact the video decoding process, e.g., for external applications. SEI messages that do not impact the decoding process may be specified in a separate specification such as a specification entitled “Versatile supplemental enhancement information messages for coded video bitstreams” (VSEI). SEI messages that may affect the decoding process may be specified in a main coding specification such as “Versatile Video Coding.”

The disclosure includes video coding and decoding, such as the application of film grain or similar noises to a part of a picture, controlled by metadata including metadata coded in a SEI message, such as a VSEI annotated region SEI message.

In an aspect, Film Grain Synthesis (FGS) is a tool aimed at maintaining an impression of an original film grain, for example, for content shot using chemical films (in contrast to digital cameras) in a digital, compressed video environment. Digitized input material may be pre-filtered, which may remove the film grain but may help the following encoding step to achieve better compression efficiency compared to input material that includes noise such as film grain. An artificial approximation of the film grain may be reinserted after reconstruction. An amount and characteristics of the noise can be part of a video bitstream, for example, in the form of metadata. ITU-T Rec. H.274, for example, includes a film grain characteristics (FGC) SEI message.

In an aspect, parameters defined in the FGC SEI message generally intend to reproduce particular film physical properties. Some examples of popular grains (or film grains) include 8 mm films with coarse grains that may be used for private film recordings such as in 1970s and 1980s, 16 mm films with noticeable grain that may be used for documentaries and TV programs, 35 mm films with a finer grain recognizable as the historical movie effect, 65-70 mm films that may be used for major movie productions, for example, those requiring VFX, and the like. The 65-70 mm films have the finest grain among the grains of the 8 mm films, the 16 mm films, the 35 mm films, and the 65-70 mm films.

In an example, signaling a type of grain may inform a client of the type of grain to be added to a video.

In an aspect, applying noise on a video may address different objectives. An objective may be for artistic intent. There are 2 cases in this category: (i) either the film grain has been removed prior to encoding and the FGC SEI message intends to reproduce the original version, (ii) or the grain is selected to provide an arbitrary artistic intent, similar to a video effect. Another objective to apply film grain is for masking visual artefacts and bringing back some textural effect, such as in cases with important loop filtered areas.

In describing the film grain, it may be beneficial to signal how important the post processing of FGS for a targeted service. A level of importance may include (i) high importance to preserve the original artistic intent, (ii) moderated importance as a subjectively preferred version, and (iii) low importance that is limited to, for example, only mask artefacts.

In some examples, video signals may be composed from multiple sources. For example, a movie with commentary may be composed of the movie content, and a surrounding frame with the commentary. The movie may have been shot using chemical film technology and hence, after digitization, may include film grain. To achieve reasonable compression, the film grain of the movie can be removed through pre-filtering. The surrounding frame may have been created by digital means and does not include film grain. After coding, transmission, and reconstruction, the resulting reconstructed pictures do not include the noise associated with the film grain of the movie, which may be for the surrounding frame and may not be for the movie as the film grain of the movie was removed through pre-filtering. Therefore, a technique in which film grain can be selectively inserted in parts of a reconstructed picture while leaving non-selected parts of the reconstructed picture free of film grain may be used. A more complex scenario may involve the inclusion of multiple movies with different film grain characteristics in a composed picture. In such a scenario, different film grain reinsertion parameters may advantageously be applied to different parts of the reconstructed picture, respectively.

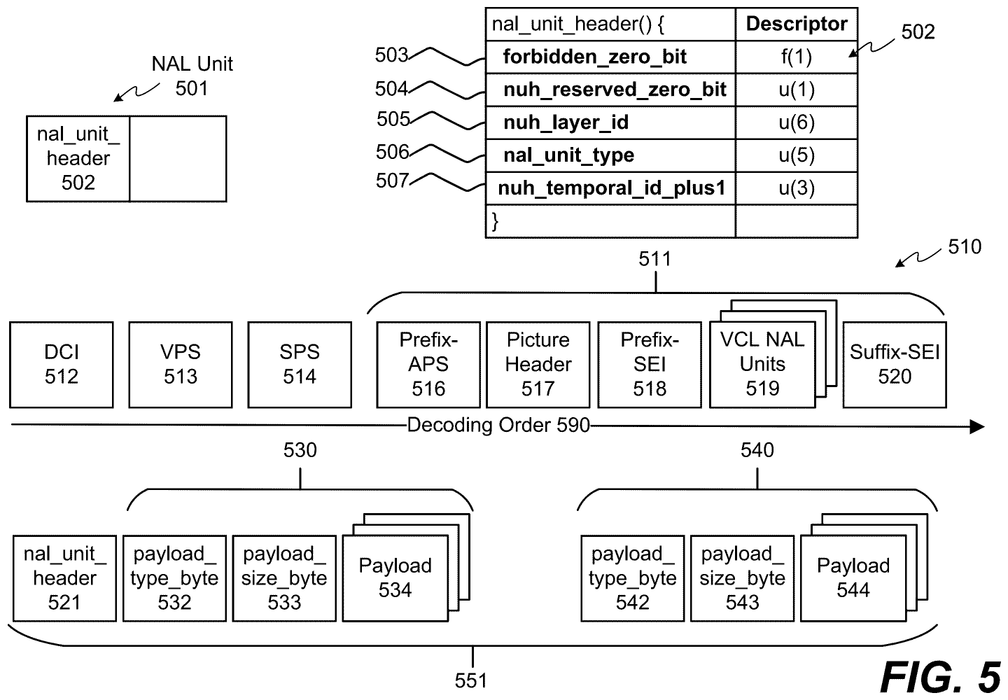

FIG. 5 shows a layout of a coded video sequence (CVS) in some examples, such as in accordance with H.266. The coded video sequence is subdivided into network abstraction layer (NAL) units (NAL units), such as an NAL unit (501) in FIG. 5. In the FIG. 5 example, the NAL unit (501) can include a NAL unit header (502). In some examples, the NAL unit header (502) includes 16 bits. In the FIG. 5 example, the NAL unit header (502) includes a first bit (e.g., a forbidden_zero_bit) (503) and a second bit (e.g., a nuh_reserved_zero_bit) (504). In an example, the first bit and the second bit are unused by H.266 and may be set to zero in a NAL unit compliant with H.266.

In the FIG. 5 example, the NAL unit header (502) includes a syntax element nuh_layer_id (505) having multiple bits (e.g., six bits). In an example, three bits of nuh_layer_id (505) may be indicative of the (spatial, SNR, or multiview enhancement) layer to which the NAL unit (501) belongs to. The NAL unit header (502) includes five bits of nuh_nal_unit_type (506) that define the type of the NAL unit (501). In some examples (e.g., H.266), among the 32 values represented by the five bits, 22 NAL unit type values are defined for NAL unit types, six NAL unit types are reserved, and four NAL unit type values are unspecified and can be used by specifications other than H.266. The NAL unit header (502) includes three bits of nuh_temporal_id_plus1 (507) to indicate the temporal layer to which the NAL unit (501) belongs to.

NAL units may be classified into video coding layer (VCL) NAL units and non-VCL NAL units. The VCL NAL units may include data that represents values of samples in video pictures, and the non-VCL NAL units may contain associated additional information such as one or more parameter sets, SEI, and/or the like.

In some examples, a coded picture can include one or more VCL NAL units and zero or more non-VCL NAL units. VCL NAL units may contain coded data conceptually belonging to a video coding layer as introduced before. Non-VCL NAL units may contain data not conceptually belonging to the video coding layer. Using H.266 as an example, the non-VCL NAL units can be categorized into, for example, categories below:
(1) Parameter sets, which include information that can be used for the decoding process and can be applied to more than one coded picture. Parameter sets and conceptually similar NAL units may be of NAL unit types (NUTs), such as DCI_NUT (Decoding Capability Information (DCI)), VPS_NUT (Video Parameter Set (VPS), establishing, among other things, layer relationships), SPS_NUT (Sequence Parameter Set (SPS), establishing, among other things, parameters used and remaining constant throughout a coded video sequence CVS), PPS_NUT (Picture Parameter Set (PPS), establishing, among other things, parameter used and remaining constant within a coded picture), and PREFIX_APS_NUT and SUFFIX_APS_NUT (prefix and suffix Adaptation Parameter Sets). Parameter sets may include information required for a decoder to decode VCL NAL units, and hence are referred here as “normative” NAL units. (2) Picture Header (PH_NUT), which is also a “normative” NAL unit.
(3) NAL units marking certain places in a NAL unit stream. The third category includes NAL units with the NAL unit types AUD_NUT (Access Unit Delimiter), EOS_NUT (End of Sequence), and EOB_NUT (End of Bitstream). The third category of NAL units are non-normative, also known as informative, in the sense that a compliant decoder does not require them for its decoding process. In an example, the compliant decoder may need to be able to receive them in the NAL unit stream.
(4) Prefix and Suffix SEI NAL unit types (PREFIX_SEI_NUT and SUFFIX_SEI_NUT) which indicate NAL units containing Prefix and Suffix supplementary enhancement information. In some examples (e.g., in H.266), the fourth category of NAL units are informative, as they are not required for the decoding process.
(5) Filler Data NAL unit type FD_NUT indicates filler data that can be random and can be used to “waste” bits in a NAL unit stream or bitstream, which may be necessary for the transport over certain isochronous transport environments.
(6) Reserved and Unspecified NAL unit types.

FIG. 5 also shows a layout of a NAL unit stream (510) in a decoding order (590) in some examples. The NAL unit stream (510) includes a coded picture (511). The NAL unit stream (510) includes, somewhere earlier than the coded picture (511), DCI (512), VPS (513), and SPS (514). DCI (512), VPS (513), and SPS (514) may, in combination, establish the parameters which the decoder can use to decode the coded pictures of a coded video sequence (CVS), including the coded picture (511) in the NAL unit stream (510).

In the FIG. 5 example, the coded picture (511) can include, in the depicted order or any other order compliant with the video coding technology or standard in use (such as H.266 shown in FIG. 5): a prefix APS (516), a picture header (PH) (617), prefix SEI (518), one or more VCL NAL units (519), and suffix SEI (520).

In some examples, the prefix SEI NAL units (518) and the suffix SEI NAL units (520) are configured during the standards development as, for some SEI messages, the content of the message may be known before the coding of a given picture commences, whereas in some examples other content may only be known when the picture has been coded. Allowing certain SEI messages to appear early or late in a coded picture's NAL unit stream through prefix and suffix SEIs may avoid buffering. For example, in an encoder, the sampling time of a picture to be coded is known before the picture is coded, and hence the picture timing SEI message can be the prefix SEI message (518). On the other hand, a decoded picture hash SEI message, which contains a hash of the sample values of a decoded pictures and can be useful, for example, to debug encoder implementations, is a suffix SEI message (520) as an encoder cannot calculate a hash over reconstructed samples before a picture has been coded. The locations of prefix and suffix SEI NAL units may not be restricted to their positions in the NAL unit stream. The phrase “prefix” and “suffix” may imply to what coded pictures or NAL units the prefix/suffix SEI message may pertain to, and the details of this applicability may be specified, for example in the semantics description of a given SEI message.

FIG. 5 also shows a diagram of a syntax of a NAL unit (551) that contains a prefix or suffix SEI message. The syntax is a container format for multiple SEI messages that can be carried in one NAL unit (also referred to as SEI NAL unit). Details of the emulation prevention syntax specified in H.266 are omitted here for clarity. As other NAL units, an SEI NAL unit may start with a NAL unit header (521). The NAL unit header (521) is followed by one or more SEI messages, such as a first SEI message (530) and a second SEI message (540) in FIG. 5. Each SEI message inside the NAL unit (551) may include an 8 bit payload_type_byte which specifies one of 256 different SEI types, such as shown by a payload_type_byte (532) and a payload_type_byte (542) in FIG. 5. Each SEI message inside the NAL unit (551) may include an 8 bit payload_size_byte which specifies a number of bytes of the SEI payload, such as shown by a payload_size_byte (533) and a payload_size_byte (543) in FIG. 5. Each SEI message inside the NAL unit (551) may include a SEI payload with the number of bytes specified by the payload_size_byte, such as a payload (534) and a payload (544) in FIG. 5. In some examples, the structure can be repeated until a payload_type_byte equal to 0xff is observed, which indicates the end of the NAL unit. The syntax of the payload may depend on the SEI message, and can be of any suitable length such as a length between 0 and 255 bytes.

In some examples, a first mechanism to further guide a receiver of a video stream with information about a type of film grain, essentiality (or importance) of the film grain, a purpose of the film grain, and/or the like may be used. The information about the type of the film grain, the essentiality of the film grain, the purpose of the film grain, and/or the like may be included in a SEI message for an FGS process such as a film grain characteristics SEI message, a FGS extension SEI message, or the like.

In some examples, a second mechanism to describe the film grain characteristics may be used.

In some examples, a third mechanism to bind together the first mechanism and the second mechanism described above may be used.

In an aspect, with regard to the first mechanism, a new SEI can be defined or descriptors for the type of the film grain, the essentiality of the film grain, the purpose of the film grain, and/or the like can be added to an existing SEI for the explicit purpose of providing additional descriptors that guide the video receiver as to the type, the essentiality of the film grain, and/or the purpose.

In an aspect, with regard to the second mechanism, a film grain SEI message may be specified, such as a film grain characteristics SEI message in VSEI, and similar information can be available in the VUI of video coding specifications. Multiple film grain SEI messages may be in a picture unit (PU), and an order of appearance of the multiple film grain SEI messages in the bitstream may be used by a decoder/a receiver (e.g., the decoder (210)) to associate a given one of the multiple film grain SEI messages with one of regions such as defined in an annotated region (AR).

In an aspect, with regard to the second mechanism, mechanisms may be used to create a binding between one or more film grain SEI messages described in the second mechanism and the additional descriptors described in the first mechanism to associate film grain characteristics conveyed by a given film grain SEI message with a region as described in the first mechanism.

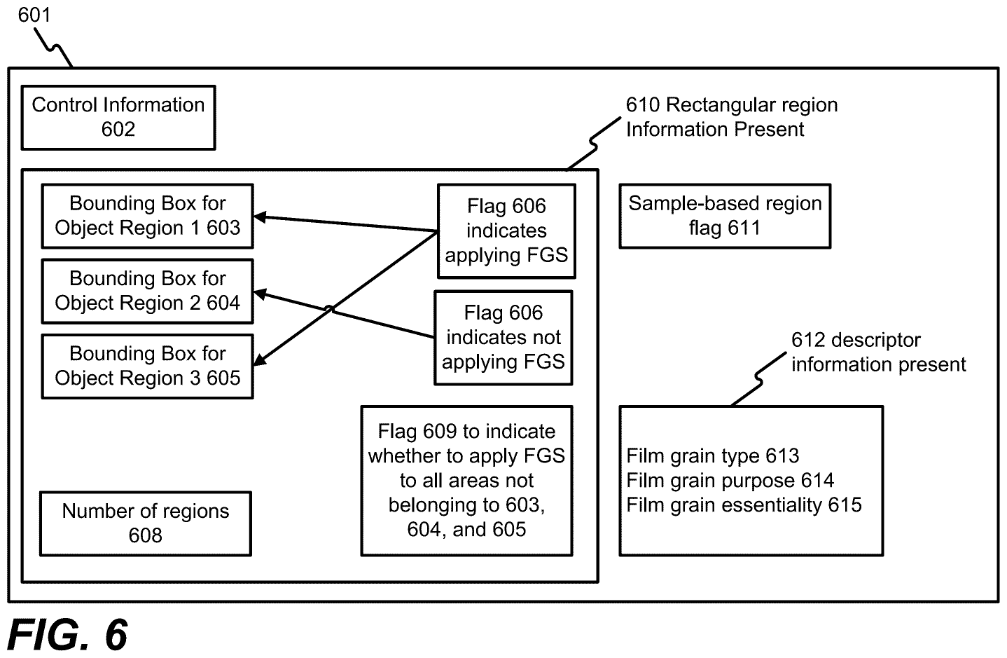

FIG. 6 shows an example of a SEI message (601) that include information indicating a type of film grain, essentiality of the film grain, and/or a purpose of the film grain according to an aspect of the disclosure. Referring to FIG. 6, the SEI message (601) is for a FGS process. In an example, the SEI message (601) may be referred to as an FGS extension SEI message as the SEI message (601) may extend an active film grain characteristics SEI message.

In an example, such as shown in FIG. 6, the FGS extension SEI message (601) may define control information and other information related to the application of the film grain in an FGS that is currently active for a picture. The picture may be associated with the SEI message (601). The other information may include descriptors (e.g., film grain descriptor information) of the film grain (e.g., the descriptors may describe the type, the essentiality, and/or the purpose of the film grain) to address the use case.

Alternatively, in another example, another SEI message which is not the FGS extension SEI message (601) as shown in FIG. 6 may be used to provide the film grain descriptor information (e.g., the film grain descriptor information may describe the type, the essentiality, and/or the purpose of the film grain) related to a currently active FGS SEI message for the picture. Thus, in this case, two SEI messages may be used including the FGS SEI message for the picture such as the film grain characteristics SEI message and the SEI message that describes the type, the essentiality, and/or the purpose of the film grain.

Referring to FIG. 6 where the FGS extension SEI message (601) is used for the carriage of the additional film grain descriptors (e.g., the type, the essentiality, and/or the purpose of the film grain), control information (602) may define the persistence of the current FGS extension SEI message (601). A flag (610) may signal if region information (e.g., rectangular region information) is present. A sample-based region flag (611) may signal that an active Alpha Channel Information (ACI) SEI message is to be used to determine sample-based regions in which to apply the FGS (or the FGS process).

Referring to FIG. 6, the SEI message (601) may include a syntax element (608) indicating a number of one or more regions that are active for the region-based application of the FGS. In the example shown in FIG. 6, the one or more regions include object regions 1-3. For the one or more regions defined by rectangles, the object region 1 (603) may define a bounding box for an area for a first rectangular region of the picture, the object region 2 (604) may define a bounding box for an area for a second rectangular region of the picture, and the object region 3 (605) may define a bounding box for a third rectangular region of the picture. Each of the regions (e.g., (603), (604), and (605)) may be accompanied by a flag (606) to indicate whether to apply the FGS or not to the respective region. A separate flag (609) may indicate whether to apply (or not apply) the FGS to areas not defined by the regions (603)-(605).

To address the use case of the additional descriptors, such as the type, the essentiality, and/or the purpose of the film grain, the SEI message (601) shown in FIG. 6 further includes a flag (612). The flag (612) may indicate if the additional descriptor information (e.g., the type, the essentiality, and/or the purpose of the film grain) is present in the SEI message (601). Descriptors (613)-(615) are shown to illustrate information related to the film grain type, the film grain purpose, and the film grain essentiality, respectively.

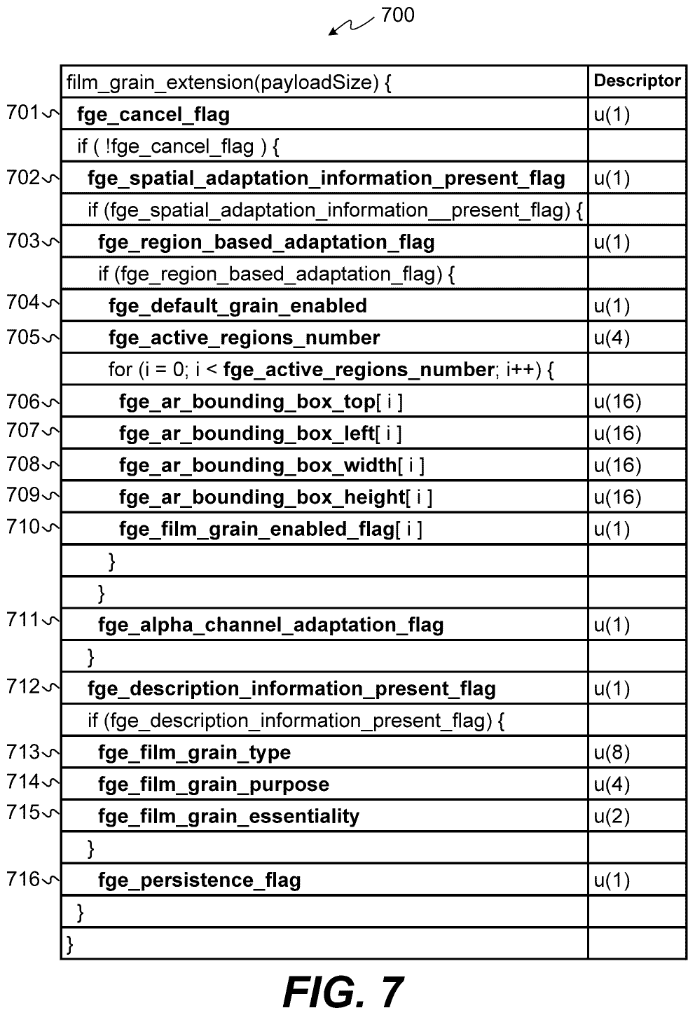

FIG. 7 shows an example of a syntax (700) that describes the SEI message (e.g., the FGS extension SEI message) (601) according to an aspect of the disclosure. In an example, the SEI message (e.g., the FGS extension SEI message) (601) is associated with a picture. In an example, a video bitstream includes the SEI message (601) and the picture. A cancel flag (e.g., a fge_cancel_flag) (701) in the syntax (700) can be used to disable the persistence of a previously processed SEI message (e.g., a previously processed FGS extension SEI message). If the cancel flag (701) is set to a value indicating ‘true’, processing of the current FGS extension SEI message may be completed. Otherwise, if the cancel flag (701) indicates that processing is to continue, for example, the cancel flag (701) is set to a value indicating ‘false’, a flag (e.g., a fge_spatial_adaptation_information_present_flag) (702) may receive a value to indicate if adaptation information for a region-based application or a sample-based application of the FGS is enabled. If the flag (702) indicates that the adaptation information for the region-based application or the sample-based application of the FGS is enabled, then a flag (e.g., a fge_region_based_adaptation_flag) (703) receives a value to indicate whether the region-based application of the FGS is enabled.

If the flag (703) indicates that the region-based application of the FGS is enabled, then a syntax element (e.g., a fge_default_grain_enabled) (704) receives a value to indicate whether areas not covered by regions defined in the SEI message (601) are to be modified by the application of the FGS. If the flag (703) indicates that the region-based application of the FGS is enabled, a number (e.g., a fge_active_regions_number) (705) receives a value indicating a number of the regions that are active for the region-based application of the FGS. For each active region (an i-th region in the picture being indicated by an index [i]) as indicated by the number (705), the following indexed variables may be received: a variable (e.g., fge_ar_bounding_box_top[i]) (706), a variable (e.g., fge_ar_bounding_box_left[i]) (707), a variable (e.g., fge_ar_bounding_box_width[i]) (708), a variable (e.g., fge_ar_bounding_box_height[i]) (709), and a flag (e.g., fge_file_grain_enabled flag[i]) (710). The indexed variables (706)-(709) may specify coordinates of a top-left corner, a width, and a height, respectively, of a bounding box of an i-th region in the picture. In an example, the variable (706) signals the coordinates of the top right corner. In an example, the variable (707) signals the coordinates of the bottom left corner. In an example, the variable (708) signals the width, and the variable (709) signals the height of the bounding box for the rectangular region (e.g., the i-th region) within the picture. The variable (710) may signal whether to apply the FGS to the region (e.g., the i-th region) within the picture. The variable (710) may or may not enable the application of the FGS to sample values that occur in the bounding box regions that overlap.

In an example, an alpha channel information flag (e.g., fge_alpha_channel_adaptation_flag) (711) is included in the syntax (700). In an example, the alpha channel information flag (e.g., fge_alpha_channel_adaptation_flag) (711) follows the above described processing for the region-based FGS. The alpha channel information flag (e.g., fge_alpha_channel_adaptation_flag) (711) may receive a value to indicate if the application of the FGS is to be weighted by an ACI SEI message if the ACI SEI message is currently active for the picture.

According to an aspect of the disclosure, the SEI message (601) associated with the picture may indicate descriptor information, such as one or more of (i) a type of film grain, (ii) a purpose of the film grain, and (iii) essentiality of the film grain, for example, in a payload of the SEI message (601). In an example, the descriptor information, such as the one or more of (i) the type of film grain, (ii) the purpose of the film grain, and (iii) the essentiality of the film grain is applied to a first region including one or more first samples in the picture. The picture that is associated with the SEI message (601) may be reconstructed.

In an example, the SEI message (e.g., the FGS extension SEI message) (601) indicates spatial information of the first region. For example, the spatial information of the first region includes a location and a size of the first region. Referring to FIG. 7, the first region is an i-th region, the location of the first region is indicated by the variable (e.g., fge_ar_bounding_box_top[i]) (706) and the variable (e.g., fge_ar_bounding_box_left[i]) (707). The size of the first region is indicated by the variable (e.g., fge_ar_bounding_box_width[i]) (708) and the variable (e.g., fge_ar_bounding_box_height[i]) (709). The first region may be of any suitable shape. In an example, the spatial information of the first region indicates that the first region is rectangular, such as shown by the variables (706)-(709) in FIG. 7. In an example, the picture includes a second region that is different from the first region, and the first region and the second region are different in the descriptor information.

A flag (e.g., fge_description_information_present_flag) (712) may indicate if the descriptor information is available in the payload of the SEI message (601). In an example, the SEI message (601) includes the flag (712) indicating that the one or more of (i) the type of the film grain, (ii) the purpose of the film grain, and (iii) the essentiality of the film grain are available in the payload of the SEI message (601).

In an example, following the above described processing for the region-based FGS and the sample-based FGS (via the ACI SEI message), the flag (e.g., fge_description_information_present_flag) (712) may receive a value to indicate if the descriptor information is available in the payload for the SEI message (601). If the flag (712) indicates that the descriptor information is available, one or more syntax elements in the syntax (700) may be used to indicate the descriptor information. The one or more syntax elements may include a syntax element (e.g., fge_film_grain_type) (713), a syntax element (e.g., fge_film_grain_purpose) (714), a syntax element (e.g., fge_film_grain_estentiality) (715), and/or the like. The syntax element (e.g., fge_film_grain_type) (713) may indicate the type of the film grain, e.g., the syntax element (e.g., fge_film_grain_type) (713) receives a value to indicate the type of the film grain. The syntax element (e.g., fge_film_grain_purpose) (714) may indicate the purpose of the film grain, e.g., the syntax element (714) receives a value to indicate the purpose of the film grain. The syntax element (e.g., fge_film_grain_estentiality) (715) may indicate the essentiality of the film grain, e.g., the syntax element (715) receives a value to indicate the essentiality of the film grain.

In an example, processing of the film grain extension is completed by a flag (e.g., fge_persistence_flag) (716). The flag (716) may receive a value that signals a range by which the current film grain extension SEI message (601) persists.

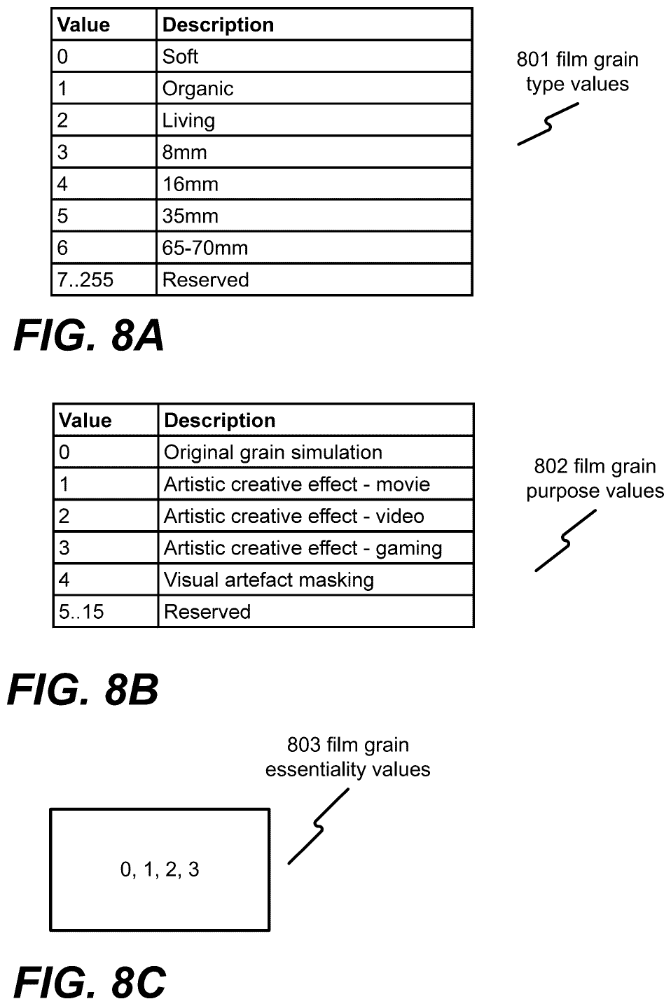

FIGS. 8A-8C show numeric values corresponding to descriptor semantics described in FIG. 7, and the numeric values may serve to differentiate descriptors for film grain.

The film grain type (also referred to as the type of the film grain) may be of any suitable film grain type. For example, the type of the film grain is one of a soft film grain type, an organic film grain type, a living film grain type, a 8 mm film grain type, a 16 mm film grain type, a 35 mm film grain type, and a 65-70 mm film grain type. The various types of the film grain may be indicated by different values of the syntax element (713). FIG. 8A shows an example of values that the syntax element (e.g., fge_film_grain_type) (713) may have according to an aspect of the disclosure. A table (801) shows an example of a relationship between values (e.g., film grain type values 0 to 255) and corresponding types of the film grain. In the example shown in FIG. 8A, the values of the syntax element fge_film_grain_type (713) may be described by the film grain type values 0 to 255 in the table (801). The value (0) corresponds to the soft film grain type, the value (1) corresponds to the organic film grain type, the value (2) corresponds to the living film grain type, the value (3) corresponds to the 8 mm film grain type, the value (4) corresponds to the 16 mm film grain type, the value (5) corresponds to the 35 mm film grain type, the value (6) corresponds to the 65-70 mm film grain type, and the values (7 to 255) are reserved for future use, for example, by the standards development organization. Table (801) shows some examples of the types of the film grain, and the types of the film grain may be modified suitably, for example, based on the applications.

The film grain purpose (also referred to as the purpose of the film grain) may be of any suitable film grain purpose. For example, the purpose of the film grain is one of a purpose for original film grain simulation, a purpose for artistic creative effect for movies, a purpose for artistic creative effect for videos, a purpose for artistic creative effect for games, and a purpose for visual artefact masking. The various purposes of the film grain may be indicated by different values of the syntax element (e.g., fge_film_grain_purpose) (714). FIG. 8B shows an example of values that the syntax element (e.g., fge_film_grain_purpose) (714) may have according to an aspect of the disclosure. A table (802) shows an example of a relationship between values (e.g., film grain purpose values 0 to 15) and corresponding purposes of the film grain. In the example shown in FIG. 8B, the values of the syntax element fge_film_grain_purpose (714) may be described by the film grain purpose values 0 to 15 in the table (802). The value (0) corresponds to an original film grain simulation, the value (1) corresponds to an artistic creative effect for movies, the value (2) corresponds to an artistic creative effect for videos, the value (3) corresponds to an artistic creative effect for games, the value (4) corresponds to the purpose of visual artefact masking, and the values (5 to 15) are reserved for future use, for example, by the standards development organization. Table (802) shows some examples of the purposes of the film grain, and the purposes of the film grain may be modified suitably, for example, based on the applications.

The film grain essentiality (also referred to as the essentiality of the film grain) may be of any suitable film grain essentiality (or importance). The essentiality of the film grain may indicate the importance of the film grain. For example, the essentiality of the film grain is indicated by one of a plurality of values that include 0 to 3. The different essentiality of the film grain may be indicated by different values of the syntax element (e.g., fge_film_grain_essentiality (715). FIG. 8C shows an example of values that the syntax element (e.g., fge_film_grain_essentiality (715) may have according to an aspect of the disclosure. A table (803) shows an example of a relationship between values (e.g., film grain essentiality values 0 to 3) and corresponding essentiality of the film grain. In the example shown in FIG. 8C, the values of the syntax element fge_film_grain_essentiality (715) may be described by the film grain essentiality values 0 to 3 in the table (803). The essentiality is the least for the value (0), greater than the value (0) but less than the value (2) for the value (1), greater than the value (1) but less than the value (3) for the value (2), and the greatest for the value (3). Table (803) shows some examples of the essentiality of the film grain, and the essentiality of the film grain may be modified suitably, for example, based on the applications.

In the above description, the SEI message (601) includes both the descriptor information such as indicated by the syntax elements (712)-(715) and the spatial information of the first region such as indicated by the variables (706)-(710). In another example, a first SEI message includes the descriptor information indicating the type, the purpose, and/or the essentiality of the film grain, and does not indicate the spatial information of the first region. Instead, a second SEI message is also associated with the picture. The second message indicates the spatial information of the first region, and does not include the descriptor information indicating the type, the purpose, and/or the essentiality of the film grain.

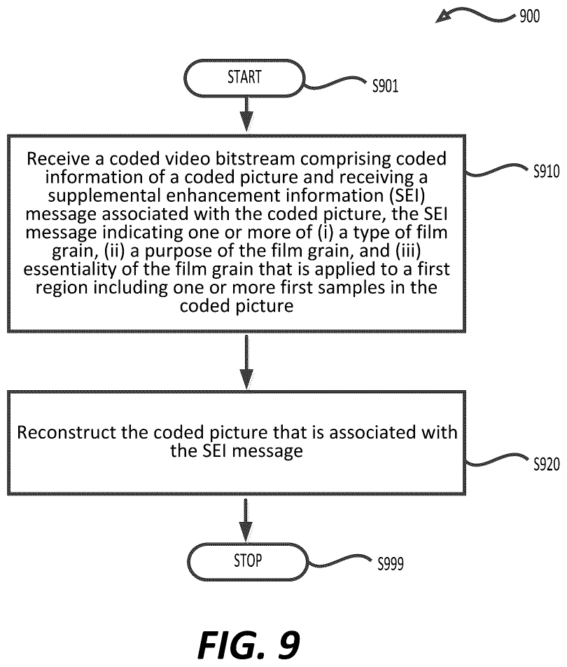

FIG. 9 shows a flow chart outlining a process (900) according to an aspect of the disclosure. The process (900) can be used in a video decoder. In various aspects, the process (900) is executed by processing circuitry, such as the processing circuitry that performs functions of the video decoder (210), the processing circuitry that performs functions of the video decoder (310), and the like. In some aspects, the process (900) is implemented in software instructions, thus when the processing circuitry executes the software instructions, the processing circuitry performs the process (900). The process starts at (S901) and proceeds to (S910).

At (S910), a coded video bitstream including coded information of a coded picture and a supplemental enhancement information (SEI) message associated with the coded picture may be received. The SEI message may indicate one or more of (i) a type of film grain, (ii) a purpose of the film grain, and (iii) essentiality of the film grain that is applied to a first region including one or more first samples in the coded picture.

In an example, the SEI message such as a film grain synthesis (FGS) extension SEI message indicates spatial information of the first region. The spatial information of the first region can include a location and a size of the first region. In an example, the spatial information of the first region indicates that the first region is rectangular.

In an example, another SEI message such as an FGS SEI message that is associated with the coded picture is received. The FGS SEI message indicates spatial information of the first region, and the SEI message is different from the FGS SEI message.

In an example, the SEI message indicates the type of film grain, and the type of the film grain is one of a soft film grain type, an organic film grain type, a living film grain type, a 8 mm film grain type, a 16 mm film grain type, a 35 mm film grain type, and a 65-70 mm film grain type.

In an example, the SEI message indicates the purpose of the film grain, and the purpose of the film grain is one of a purpose for original film grain simulation, a purpose for artistic creative effect for movies, a purpose for artistic creative effect for videos, a purpose for artistic creative effect for games, and a purpose for visual artefact masking.

In an example, the SEI message indicates the essentiality of the film grain, and the essentiality of the film grain is indicated by one of a plurality of values that include 0 to 3.

In an example, the SEI message includes a flag indicating that the one or more of (i) the type of the film grain, (ii) the purpose of the film grain, and (iii) the essentiality of the film grain are available in a payload of the SEI message.

In an example, the coded picture includes a second region that is different from the first region.

In an example, the coded video bitstream includes the SEI message.

At (S920), the coded picture that is associated with the SEI message may be reconstructed.

Then, the process proceeds to (S999) and terminates.

The process (900) can be suitably adapted. Step(s) in the process (900) can be modified and/or omitted. Additional step(s) can be added. Any suitable order of implementation can be used.

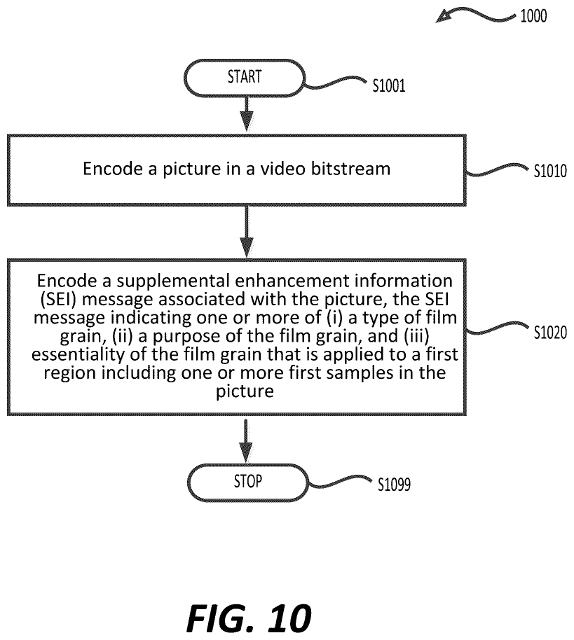

FIG. 10 shows a flow chart outlining a process (1000) according to an aspect of the disclosure. The process (1000) can be used in a video encoder. In various aspects, the process (1000) is executed by processing circuitry, such as the processing circuitry that performs functions of the video encoder (203), the processing circuitry that performs functions of the video encoder (403), and the like. In some aspects, the process (1000) is implemented in software instructions, thus when the processing circuitry executes the software instructions, the processing circuitry performs the process (1200). The process starts at (S1001) and proceeds to (S1010).

At (S1010), a picture in a video bitstream is encoded.

At (S1020), a supplemental enhancement information (SEI) message associated with the picture may be encoded. The SEI message indicates one or more of (i) a type of film grain, (ii) a purpose of the film grain, and (iii) essentiality of the film grain that is applied to a first region including one or more first samples in the picture.

In an example, the SEI message is a film grain synthesis (FGS) extension SEI message that indicates spatial information of the first region.

In an example, another SEI message such as an FGS SEI message associated with the picture is encoded. The FGS SEI message indicates spatial information of the first region, and the SEI message being different from the FGS SEI message.

In an example, the SEI message indicates the type of film grain, and the type of the film grain is one of a soft film grain type, an organic film grain type, a living film grain type, a 8 mm film grain type, a 16 mm film grain type, a 35 mm film grain type, and a 65-70 mm film grain type.

In an example, the SEI message indicates the purpose of the film grain, and the purpose of the film grain is one of a purpose for original film grain simulation, a purpose for artistic creative effect for movies, a purpose for artistic creative effect for videos, a purpose for artistic creative effect for games, and a purpose for visual artefact masking.

In an example, the SEI message indicates the essentiality of the film grain, and the essentiality of the film grain is indicated by one of a plurality of values that include 0 to 3.

In an example, the SEI message includes a flag indicating that the one or more of (i) the type of the film grain, (ii) the purpose of the film grain, and (iii) the essentiality of the film grain are available in a payload of the SEI message.

In an example, the video bitstream includes the SEI message.

Then, the process proceeds to (S1099) and terminates.

The process (1000) can be suitably adapted. Step(s) in the process (1000) can be modified and/or omitted. Additional step(s) can be added. Any suitable order of implementation can be used.

A method of processing visual media data is disclosed. The method may include processing a bitstream of the visual media data according to a format rule. The bitstream may include coded information of a coded picture, a supplemental enhancement information (SEI) message being associated with the coded picture, the SEI message indicating one or more of (i) a type of film grain, (ii) a purpose of the film grain, and (iii) essentiality of the film grain that is applied to a first region including one or more first samples in the coded picture. The format rule specifies that the coded picture that is associated with the SEI message is reconstructed.

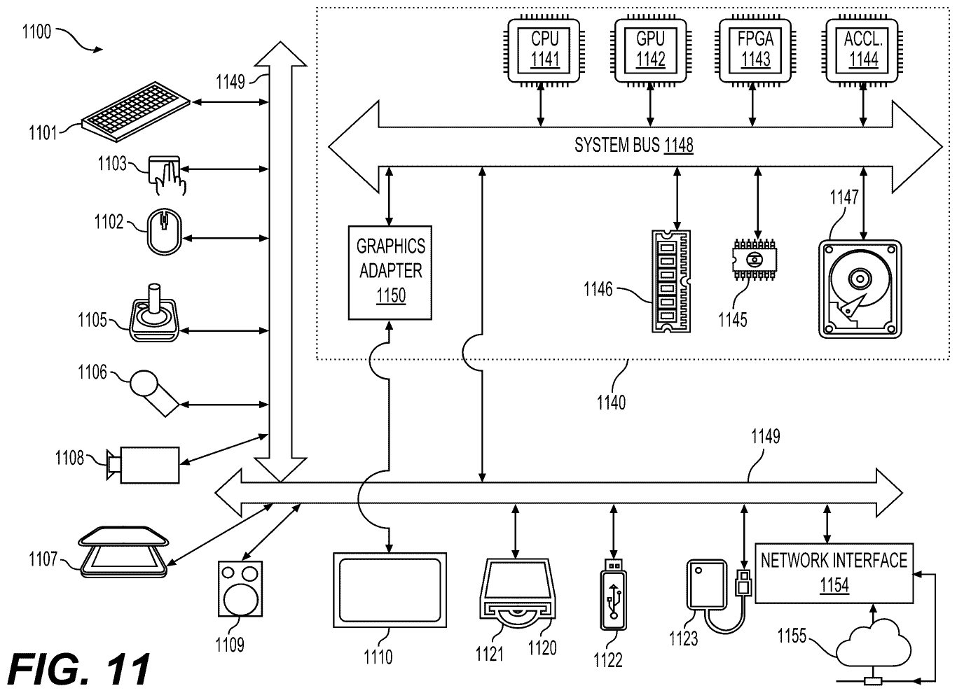

The techniques including techniques for descriptors for film grain synthesis described above can be implemented as computer software using computer-readable instructions and physically stored in one or more computer-readable media. For example, FIG. 11 shows a computer system (1100) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 11 for computer system (1100) are exemplary in nature and are not intended to suggest any limitation as to the scope of use or functionality of the computer software implementing aspects of the present disclosure. Neither should the configuration of components be interpreted as having any dependency or requirement relating to any one or combination of components illustrated in the exemplary aspect of a computer system (1100).

Computer system (1100) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1101), mouse (1102), trackpad (1103), touch screen (1110), data-glove (not shown), joystick (1105), microphone (1106), scanner (1107), camera (1108).

Computer system (1100) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1110), data-glove (not shown), or joystick (1105), but there can also be tactile feedback devices that do not serve as input devices), audio output devices (such as: speakers (1109), headphones (not depicted)), visual output devices (such as screens (1110) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (1100) can also include human accessible storage devices and their associated media such as optical media including CD/DVD ROM/RW (1120) with CD/DVD or the like media (1121), thumb-drive (1122), removable hard drive or solid state drive (1123), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1100) can also include an interface (1154) to one or more communication networks (1155). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1149) (such as, for example USB ports of the computer system (1100)); others are commonly integrated into the core of the computer system (1100) by attachment to a system bus as described below (for example Ethernet interface into a PC computer system or cellular network interface into a smartphone computer system). Using any of these networks, computer system (1100) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1140) of the computer system (1100).

The core (1140) can include one or more Central Processing Units (CPU) (1141), Graphics Processing Units (GPU) (1142), specialized programmable processing units in the form of Field Programmable Gate Areas (FPGA) (1143), hardware accelerators for certain tasks (1144), graphics adapters (1150), and so forth. These devices, along with Read-only memory (ROM) (1145), Random-access memory (1146), internal mass storage such as internal non-user accessible hard drives, SSDs, and the like (1147), may be connected through a system bus (1148). In some computer systems, the system bus (1148) can be accessible in the form of one or more physical plugs to enable extensions by additional CPUs, GPU, and the like. The peripheral devices can be attached either directly to the core's system bus (1148), or through a peripheral bus (1149). In an example, the screen (1110) can be connected to the graphics adapter (1150). Architectures for a peripheral bus include PCI, USB, and the like.

CPUs (1141), GPUs (1142), FPGAs (1143), and accelerators (1144) can execute certain instructions that, in combination, can make up the aforementioned computer code. That computer code can be stored in ROM (1145) or RAM (1146). Transitional data can also be stored in RAM (1146), whereas permanent data can be stored for example, in the internal mass storage (1147). Fast storage and retrieve to any of the memory devices can be enabled through the use of cache memory, that can be closely associated with one or more CPU (1141), GPU (1142), mass storage (1147), ROM (1145), RAM (1146), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1100), and specifically the core (1140) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1140) that are of non-transitory nature, such as core-internal mass storage (1147) or ROM (1145). The software implementing various aspects of the present disclosure can be stored in such devices and executed by core (1140). A computer-readable medium can include one or more memory devices or chips, according to particular needs. The software can cause the core (1140) and specifically the processors therein (including CPU, GPU, FPGA, and the like) to execute particular processes or particular parts of particular processes described herein, including defining data structures stored in RAM (1146) and modifying such data structures according to the processes defined by the software. In addition or as an alternative, the computer system can provide functionality as a result of logic hardwired or otherwise embodied in a circuit (for example: accelerator (1144)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several exemplary aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.
(1) A method of video decoding, the method including: receiving a coded video bitstream comprising coded information of a coded picture and receiving a supplemental enhancement information (SEI) message associated with the coded picture, the SEI message indicating one or more of (i) a type of film grain, (ii) a purpose of the film grain, and (iii) essentiality of the film grain that is applied to a first region including one or more first samples in the coded picture; and reconstructing the coded picture that is associated with the SEI message.
(2) The method of feature (1), in which the SEI message is a film grain synthesis (FGS) extension SEI message that indicates spatial information of the first region.
(3) The method of feature (2), in which the spatial information of the first region comprises a location and a size of the first region.
(4) The method of any features (2) to (3), in which the spatial information of the first region indicates that the first region is rectangular.
(5) The method of feature (1), in which the method includes receiving a film grain synthesis (FGS) SEI message that is associated with the coded picture, the FGS SEI message indicates spatial information of the first region, and the SEI message is different from the FGS SEI message.
(6) The method of any features (1) to (5), in which the SEI message indicates the type of film grain, and the type of the film grain is one of a soft film grain type, an organic film grain type, a living film grain type, a 8 mm film grain type, a 16 mm film grain type, a 35 mm film grain type, and a 65-70 mm film grain type.
(7) The method of any features (1) to (6), in which the SEI message indicates the purpose of the film grain, and the purpose of the film grain is one of a purpose for original film grain simulation, a purpose for artistic creative effect for movies, a purpose for artistic creative effect for videos, a purpose for artistic creative effect for games, and a purpose for visual artefact masking.
(8) The method of any features (1) to (7), in which the SEI message indicates the essentiality of the film grain, and the essentiality of the film grain is indicated by one of a plurality of values that include 0 to 3.
(9) The method of any features (1) to (8), in which the SEI message includes a flag indicating that the one or more of (i) the type of the film grain, (ii) the purpose of the film grain, and (iii) the essentiality of the film grain are available in a payload of the SEI message.
(10) The method of any features (1) to (9), in which the coded picture includes a second region that is different from the first region.
(11) The method of any features (1) to (10), in which the coded video bitstream includes the SEI message.
(12) A method of video encoding, the method including: encoding a picture in a video bitstream; and encoding a supplemental enhancement information (SEI) message associated with the picture, the SEI message indicating one or more of (i) a type of film grain, (ii) a purpose of the film grain, and (iii) essentiality of the film grain that is applied to a first region including one or more first samples in the picture.
(13) The method of feature (12), in which the SEI message is a film grain synthesis (FGS) extension SEI message that indicates spatial information of the first region.
(14) The method of feature (12), in which the method includes encoding a film grain synthesis (FGS) SEI message associated with the picture, the FGS SEI message indicating spatial information of the first region, and the SEI message being different from the FGS SEI message.
(15) The method of any features (12) to (14), in which the SEI message indicates the type of film grain, and the type of the film grain is one of a soft film grain type, an organic film grain type, a living film grain type, a 8 mm film grain type, a 16 mm film grain type, a 35 mm film grain type, and a 65-70 mm film grain type.
(16) The method of any features (12) to (15), in which the SEI message indicates the purpose of the film grain, and the purpose of the film grain is one of a purpose for original film grain simulation, a purpose for artistic creative effect for movies, a purpose for artistic creative effect for videos, a purpose for artistic creative effect for games, and a purpose for visual artefact masking.
(17) The method of any features (12) to (16), in which the SEI message indicates the essentiality of the film grain, and the essentiality of the film grain is indicated by one of a plurality of values that include 0 to 3.
(18) The method of any features (12) to (17), in which the SEI message includes a flag indicating that the one or more of (i) the type of the film grain, (ii) the purpose of the film grain, and (iii) the essentiality of the film grain are available in a payload of the SEI message.
(19) The method of any features (12) to (18), in which the coded video bitstream includes the SEI message.
(20) A method of processing visual media data, the method including: processing a bitstream of the visual media data according to a format rule, wherein the bitstream includes coded information of a coded picture, a supplemental enhancement information (SEI) message being associated with the coded picture, the SEI message indicating one or more of (i) a type of film grain, (ii) a purpose of the film grain, and (iii) essentiality of the film grain that is applied to a first region including one or more first samples in the coded picture; and the format rule specifies that the coded picture that is associated with the SEI message is reconstructed.
(21) An apparatus for video decoding, including processing circuitry that is configured to perform the method of any of features (1) to (11).
(22) An apparatus for video encoding, including processing circuitry that is configured to perform the method of any of features (12) to (19).
(23) A non-transitory computer-readable storage medium storing instructions which when executed by at least one processor cause the at least one processor to perform the method of any of features (1) to (20).

What is claimed is:

1. A method of video decoding, comprising:
receiving a coded video bitstream comprising coded information of a coded picture and receiving a supplemental enhancement information (SEI) message associated with the coded picture, the SEI message indicating one or more of (i) a type of film grain, (ii) a purpose of the film grain, and (iii) essentiality of the film grain that is applied to a first region including one or more first samples in the coded picture; and
reconstructing the coded picture that is associated with the SEI message.

2. The method of claim 1, wherein the SEI message is a film grain synthesis (FGS) extension SEI message that indicates spatial information of the first region.

3. The method of claim 2, wherein the spatial information of the first region comprises a location and a size of the first region.

4. The method of claim 2, wherein the spatial information of the first region indicates that the first region is rectangular.

5. The method of claim 1, wherein
the method includes receiving a film grain synthesis (FGS) SEI message that is associated with the coded picture,
the FGS SEI message indicates spatial information of the first region, and
the SEI message is different from the FGS SEI message.

6. The method of claim 1, wherein the SEI message indicates the type of film grain, and the type of the film grain is one of a soft film grain type, an organic film grain type, a living film grain type, a 8 mm film grain type, a 16 mm film grain type, a 35 mm film grain type, and a 65-70 mm film grain type.

7. The method of claim 1, wherein the SEI message indicates the purpose of the film grain, and the purpose of the film grain is one of a purpose for original film grain simulation, a purpose for artistic creative effect for movies, a purpose for artistic creative effect for videos, a purpose for artistic creative effect for games, and a purpose for visual artefact masking.

8. The method of claim 1, wherein the SEI message indicates the essentiality of the film grain, and the essentiality of the film grain is indicated by one of a plurality of values that include 0 to 3.

9. The method of claim 1, wherein the SEI message includes a flag indicating that the one or more of (i) the type of the film grain, (ii) the purpose of the film grain, and (iii) the essentiality of the film grain are available in a payload of the SEI message.

10. The method of claim 1, wherein the coded picture includes a second region that is different from the first region.

11. The method of claim 1, wherein the coded video bitstream includes the SEI message.

12. A method of video encoding, comprising:
encoding a picture in a video bitstream; and
encoding a supplemental enhancement information (SEI) message associated with the picture, the SEI message indicating one or more of (i) a type of film grain, (ii) a purpose of the film grain, and (iii) essentiality of the film grain that is applied to a first region including one or more first samples in the picture.

13. The method of claim 12, wherein the SEI message is a film grain synthesis (FGS) extension SEI message that indicates spatial information of the first region.

14. The method of claim 12, further comprising:
encoding a film grain synthesis (FGS) SEI message associated with the picture, the FGS SEI message indicating spatial information of the first region, and the SEI message being different from the FGS SEI message.

15. The method of claim 12, wherein the SEI message indicates the type of film grain, and the type of the film grain is one of a soft film grain type, an organic film grain type, a living film grain type, a 8 mm film grain type, a 16 mm film grain type, a 35 mm film grain type, and a 65-70 mm film grain type.

16. The method of claim 12, wherein the SEI message indicates the purpose of the film grain, and the purpose of the film grain is one of a purpose for original film grain simulation, a purpose for artistic creative effect for movies, a purpose for artistic creative effect for videos, a purpose for artistic creative effect for games, and a purpose for visual artefact masking.

17. The method of claim 12, wherein the SEI message indicates the essentiality of the film grain, and the essentiality of the film grain is indicated by one of a plurality of values that include 0 to 3.

18. The method of claim 12, wherein the SEI message comprises a flag indicating that the one or more of (i) the type of the film grain, (ii) the purpose of the film grain, and (iii) the essentiality of the film grain are available in a payload of the SEI message.

19. The method of claim 12, wherein the video bitstream comprises the SEI message.

20. A method of processing visual media data, the method comprising:
processing a bitstream of the visual media data according to a format rule, wherein
the bitstream includes coded information of a coded picture, a supplemental enhancement information (SEI) message being associated with the coded picture, the SEI message indicating one or more of (i) a type of film grain, (ii) a purpose of the film grain, and (iii) essentiality of the film grain that is applied to a first region including one or more first samples in the coded picture; and
the format rule specifies that the coded picture that is associated with the SEI message is reconstructed.
